(19) United States
(12) Patent Application Publication
(10) Pub. No.: US 2025/0143289 A1
(43) Pub. Date: May 8, 2025

(54) BIO-CONTROL COMBINATIONS, COMPOSITIONS AND METHOD OF USE

(71) Applicant: DECCO WORLDWIDE POST-HARVEST HOLDINGS B.V., ROTTERDAM (NL)

(72) Inventor: CLARA MONTESINOS, VALENCIA (ES)

(21) Appl. No.: 18/835,916

(22) PCT Filed: Feb. 7, 2023
(86) PCT No.: PCT/EP2023/052975

§ 371 Date: Aug. 5, 2024

(30) Foreign Application Priority Data
Feb. 8, 2022 (EP) 22382102.6

(51) Int. Cl. A01N 3/00; A01N 63/32; A01P 3/00; A23B 7/155; A23B 7/157

(52) U.S. Cl. CPC A01N 3/00; A01N 63/32; A01P 3/00; A23B 7/155; A23B 7/157

(57) ABSTRACT

The present invention relates to bio-control combinations and compositions thereof. The biocontrol combinations accordingly comprise an antagonist yeast and a bicarbonate salt for effectively controlling post-harvest fungal diseases in agricultural produce. The present invention further relates to a method of controlling post-harvest plant pathogenic diseases in agricultural produce. More particularly, the present invention relates to a method of controlling and preventing post-harvest fungal diseases in agricultural produce.

### TECHNICAL FIELD

The present invention relates to bio-control combinations and compositions thereof. The present invention further relates to a method of control of plant pathogenic diseases in agricultural produce. More particularly, the present invention relates to a method of controlling and preventing post-harvest diseases in agricultural produce.

### BACKGROUND AND PRIOR ART

Fruit and vegetables are a major source of food globally. However, more than a third of fruits and vegetables fail to reach the customer due to infections caused by pathogens or due to decay or spoilage of produce after harvest. This leads to massive economic and social losses. This loss is greatly attributable to fungal and bacterial infections. Diseases caused by such infections are likely to appear in the field (i.e., pre-harvest), but also appear or affect the fruit post-harvest. Post-harvest decay of fruits and vegetables can be traced to infections that occur either between flowering and fruit maturity or during harvesting and subsequent handling and storage. Post-harvest losses impact fruit production and quality, resulting in losses of an average of 22.5% of the yield in developing countries.

Both quantitative and qualitative losses occur at all stages in the post-harvest handling system of the distribution chain of perishables from harvesting, through handling, packing, storage and transportation to final delivery of the fresh produce to the consumer.

Post-harvest treatment of agricultural produce with biological control using antagonistic microorganisms can be considered as an effective approach to control postharvest rot in produce. The emphasis on a biological mode of control against chemical control is due to environmental concerns, the emergence of resistant pathogen strains against chemical pesticides, or the restriction on the use of chemical pesticides.

There exists a need in the art to provide a fungicide for the control and prevention of fungal diseases in agricultural produce to minimize losses in the post-harvest handling system.

### OBJECT

It is an object of the present invention to provide bio-control combinations for the control and prevention of post-harvest infections in agricultural produce.

It is an object of the present invention to provide biocontrol compositions for the control and prevention of post-harvest infections in agricultural produce.

It is another object of the present invention to provide a method for the biocontrol and prevention of post-harvest fungal infections.

It is yet another object of the present invention to provide a method for the control and prevention of fungal diseases in agricultural produce.

Particularly, it is an object of the present invention to provide a method for controlling and preventing pathogenic fungal diseases in banana.

It is a further object of the present invention to provide a method for controlling and preventing pathogenic fungal diseases in citrus fruits.

It is yet another object of the present invention to provide a method for controlling and preventing pathogenic fungal diseases in stone fruits.

It is yet another object of the present invention to provide a method for controlling and preventing pathogenic fungal diseases in pome fruits.

### SUMMARY

The present invention provides a bio-control combinations, compositions and a method of controlling and preventing postharvest diseases in agricultural produce.

The present invention provides a bio-control combination comprising,
(a) a biological component comprising an antagonistic yeast; and
(b) a stabilizing amount of dissolved inorganic carbon added in the form of a bicarbonate or carbonate salt of an alkali or alkaline earth metal.

In an aspect, the present invention provides a bio-control combination comprising,
(a) a biological component comprising Candida oleophila; and
(b) a stabilizing amount of dissolved inorganic carbon added in the form of a bicarbonate or a carbonate salt of an alkali or alkaline earth metal.

In an aspect, the present invention provides a bio-control combination comprising,
(a) a biological component comprising Candida oleophila strain O; and
(b) a bicarbonate or a carbonate salt of an alkali or alkaline earth metal.

In an aspect, the present invention provides a bio-control combination comprising Candida oleophila and a bicarbonate or carbonate salt of a metal.

In an aspect, the present invention provides a bio-control combination comprising Candida oleophila and a bicarbonate salt of a metal.

In an aspect, the present invention provides a bio-control combination comprising Candida oleophila and a carbonate salt of a metal.

In another aspect, the present invention provides a bio-control combination comprising Candida oleophila and sodium bicarbonate.

In another aspect, the present invention provides a bio-control combination comprising Candida oleophila strain O and sodium bicarbonate.

The present invention provides a bio-control composition comprising,
(a) a biological component comprising Candida oleophila; and
(b) a stabilizing amount of dissolved inorganic carbon added in the form of a bicarbonate or carbonate salt of an alkali or alkaline earth metal.

In an aspect, the present invention provides a bio-control composition comprising,
(a) a biological component comprising Candida oleophila strain O; and
(b) a stabilizing amount of a bicarbonate or a carbonate salt of an alkali or alkaline earth metal.

In an aspect, the present invention provides a bio-control composition comprising Candida oleophila and a bicarbonate or carbonate salt of an alkali or alkaline earth metal.

In an aspect, the present invention provides a bio-control composition comprising Candida oleophila and a bicarbonate salt of an alkali or alkaline earth metal.

In an aspect, the present invention provides a bio-control composition comprising Candida oleophila and a carbonate salt of an alkali or alkaline earth metal.

In a further aspect, the present invention provides a bio-control composition further comprising a buffering agent.

In another aspect, the present invention provides a method for controlling and preventing post-harvest diseases in agricultural produce, comprising applying the bio-control combination or a composition comprising the said combination to agricultural produce.

In yet another aspect, the present invention provides use of the bio-control combination comprising Candida oleophila and a bicarbonate or carbonate salt of an alkali or alkaline earth metal for controlling and preventing post-harvest diseases.

### DETAILED DESCRIPTION

The present invention relates to biocontrol combinations, compositions and methods to reduce the incidence and/or severity of fungal pathogens, and economic loss in agricultural produce.

The present invention further relates to methods of use of the biocontrol combinations and compositions comprising antagonistic yeast, articles including kits comprising those combinations, compositions and methods of use.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term ‘fungicide or fungicidal’ refers to pesticides that kill or prevent the growth of fungi and their spores in agriculture.

The term ‘disease control’ as used herein denotes control and prevention of a disease. Controlling effects include all deviation from natural development, for example: killing, retardation, decrease of the fungal disease.

The term ‘antagonistic yeast’ refers to yeast having anti-fungal, anti-bacterial, anti-insecticidal and anti-viral activity. It may be noted that references to yeast also include references to antagonistic yeast, and such terms may be used interchangeably for the purposes of the present invention.

The term ‘plants’ refers to all physical parts of a plant, including seeds, seedlings, saplings, roots, tubers, stems, stalks, foliage and fruits.

The term “agricultural produce” as used herein refers to any produce out of cultivation of plants including cultivated plants, foliage, fruits, root/tuber crops and vegetables.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term “agriculturally acceptable amount of active” refers to an amount of an active that kills or inhibits the plant disease for which control is desired, in an amount not significantly toxic to the plant being treated.

The term ‘stabilizing amount’ refers to the amount of carbonate or bicarbonate salt in the bio-control combination that is effective to maintain the viability of the microbial species over a time period.

The term ‘biologically effective amount’ refers to the amount of the biological component used to inhibit, reduce or stunt the occurrence of infections in agricultural practices.

“Grapes”, as used in this specification and the accompanying claims, includes table grapes and wine grapes.

“Citrus fruit”, as used in this specification and the accompanying claims, includes, but is not limited to, oranges, grapefruit, tangerines, clementines, lemons, limes, kumqwat, citroen, pomello, mandarin and hydrids derived therefrom.

“Pome fruit”, as used in this specification includes, but is not limited to, apples, pears and quinces.

“Stone fruit”, as used in this specification includes, but is not limited to, peaches, plums, nectarines, apricots, mangos.

For purposes of this specification and the accompanying claims the terms “inhibiting” and “inhibition” refer to retardation or delay of a process. As such, inhibition may be deemed to occur if the process occurs at a reduced rate as a result of application of a claimed yeast, a composition containing such a yeast, or as a result of practice of a claimed method.

As used herein, colony forming unit (cfu) is a unit which estimates the number of microbial cells, i.e. cells of Candida oleophila that are viable in an application sample.

As used herein, the term metric ton or tonne is a unit of mass, and it is defined as 1,000 kilograms. The said terms are used interchangeably.

Each of the aspects described above may have one or more embodiments.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

The inventors of the present invention have unexpectedly found that contacting agricultural produce or harvest with a bio-control combination or a composition comprising Candida oleophila and a source of inorganic carbon resulted in considerable reduction in the occurrence of fungal decay in said agricultural produce. More particularly, the inventors of the present invention observed that contacting fruits with the said bio-control combination or composition resulted in significant reduction in fungal decay and in loss of harvest, therefore contributing to the reduction in economic losses. The inventors of the present invention also provide that the present combination or composition can be used for controlling fungal infections in or on plant tissue without phytotoxicity.

The present invention provides a bio-control combination comprising an antagonistic yeast and a bicarbonate or carbonate salt of a metal, for controlling and preventing post-harvest diseases in agricultural produce including cultivated plants, foliage, fruits, root/tuber crops and vegetables.

The present invention provides a bio-control combination comprising;
(a) a biologically effective amount of an antagonistic yeast; and
(b) a stabilizing amount of dissolved inorganic carbon added in the form of a bicarbonate or carbonate salt of an alkali or alkaline earth metal.

In an embodiment, the biological component comprises an antagonistic yeast species selected from Candida sp. Saccharomyces sp. Candida oleophila, Saccharomyces cerevisiae, Saccharomyces pombe and the like.

In a preferred embodiment, Candida oleophila includes all strains of C. oleophila, mostly, C. oleophila strain O or C. oleophila I-182.

In a preferred embodiment, the present invention provides a bio-control combination comprising;
(a) a biologically effective amount of Candida oleophila; and
(b) a stabilizing amount of dissolved inorganic carbon added in the form of a bicarbonate or carbonate salt of an alkali or alkaline earth metal.

In an embodiment, the ratio of the dissolved inorganic carbon content and the available free chlorine content is ranging from 1% to 5% w/v.

In one preferred embodiment, the present invention provides a bio-control combination comprising;
(a) a biologically effective amount of Candida oleophila; and
(b) a stabilizing amount of a bicarbonate salt of an alkali or alkaline earth metal.

In one preferred embodiment, the present invention provides a bio-control combination comprising;
(a) a biologically effective amount of Candida oleophila; and
(b) a stabilizing amount of sodium bicarbonate.

In one preferred embodiment, the present invention provides a bio-control combination for controlling and preventing post-harvest diseases in agricultural produce, the combination comprising;
(a) a biologically effective amount of Candida oleophila; and
(b) a stabilizing amount of sodium bicarbonate.

Biological source and deposition details: Candida oleophila Montrocher strain O deposited under MUCL-40564, both deposited on Jun. 17, 1997 at the BBCM™/MUCL Culture Collection of the Mycotheque de l′Universite Catholique de Louvain, and Candida oleophila Montrocher commercial strain 1-182.

In an embodiment, the present invention provides a bio-control combination comprising;
(a) a biologically effective amount of Candida oleophila Montrocher strain O, MUCL-40564; and
(b) a stabilizing amount of a bicarbonate or carbonate salt of an alkali or alkaline earth metal.

In an embodiment, the present invention provides a bio-control combination comprising Candida oleophila and a bicarbonate or a carbonate salt of an alkali or alkaline earth metal.

In an embodiment, the present invention provides a bio-control combination comprising Candida oleophila strain O and a bicarbonate or a carbonate salt of an alkali or alkaline earth metal.

In an embodiment, the present invention provides a bio-control combination comprising a bicarbonate or carbonate salt of an alkali or alkali earth metal selected from sodium, calcium or potassium.

In an embodiment, the bicarbonate salt comprises sodium bicarbonate, sodium carbonate, calcium carbonate, calcium bicarbonate, potassium carbonate and potassium bicarbonate.

In a preferred embodiment, the sodium salt is sodium bicarbonate.

In an embodiment, the bio-control combination comprises Candida oleophila and a bicarbonate or carbonate salt of a metal is in a weight ratio of 0.01:1 to 1:5.

In a preferred embodiment, the bio-control combination comprises Candida oleophila and a bicarbonate or carbonate salt of a metal is in a weight ratio of 0.1:1.

In a preferred embodiment, the bio-control combination comprises Candida oleophila strain O and sodium bicarbonate in a weight ratio from 0.01:1 to 1:5.

In a preferred embodiment, the bio-control combination comprises Candida oleophila strain O and sodium bicarbonate in a weight ratio from 0.1:1.

In an embodiment, Candida oleophila is in a concentration from 0.1 to 5% w/v of the combination.

In a preferred embodiment, Candida oleophila is in a concentration from 0.1 to 3% w/v of the combination.

In an embodiment, Candida oleophila strain O is in a concentration from 0.1 to 5% w/v of the combination.

In a preferred embodiment, Candida oleophila strain O is in a concentration from 0.1 to 3% w/v of the combination.

Accordingly, the biologically effective amount of Candida oleophila is from 0.1×10¹ cfu/g to 5×10¹⁵ cfu/g of the combination.

In an embodiment, the biologically effective amount of Candida oleophila is from 0.5×10¹⁰ cfu/g to 5×10¹⁰ cfu/g of the combination.

In a preferred embodiment, the biologically effective amount of Candida oleophila is from 1×10¹⁰ cfu/g to 4×10¹⁰ cfu/g of the combination.

In a preferred embodiment, the biologically effective amount of Candida oleophila is 3×10¹⁰ cfu/g of the combination.

In an embodiment, the stabilizing amount of bicarbonate or carbonate salt of an alkali or alkaline earth metal is ranging from 0.1% to 10% w/v of the combination.

In a preferred embodiment, the stabilizing amount of bicarbonate or carbonate salt of an alkali or alkaline earth metal is ranging from 1% to 5% w/v by weight of the combination.

In an embodiment, the stabilizing amount of sodium bicarbonate is ranging from 0.1% to 10% w/v of the combination.

In a preferred embodiment, the stabilizing amount of sodium bicarbonate is ranging from 1% to 5% w/v by weight of the combination.

In an embodiment, the present invention provides a bio-control combination comprising;
(i) a biologically effective amount of Candida oleophila in a concentration ranging from 0.1 to 5% w/v by weight of the combination; and
(ii) a stabilizing amount of a bicarbonate or carbonate salt of an alkali or alkaline earth metal ranging from 0.1% to 10% w/v by weight of the combination.

In an embodiment, the present invention provides a bio-control combination comprising;
(i) a biologically effective amount of Candida oleophila in a concentration from 0.1 to 3% w/v by weight of the combination; and
(ii) a stabilizing amount of a bicarbonate or carbonate salt of an alkali or alkaline earth metal ranging from 1% to 5% w/v by weight of the combination.

In an embodiment, the present invention provides a bio-control combination comprising;
(i) a biologically effective amount of Candida oleophila Montrocher strain O, MUCL-40564 in a concentration from 0.1 to 5% w/v of the combination; and
(ii) a stabilizing amount of sodium bicarbonate ranging from 0.1% to 10% w/v by weight of the combination.

In an embodiment, the present invention provides a bio-control combination comprising;
(i) a biologically effective amount of Candida oleophila Montrocher strain O, MUCL-40564 in a concentration from 0.1 to 3% w/v of the combination; and
(ii) a stabilizing amount of sodium bicarbonate ranging from 1% to 5% w/v by weight of the combination.

In an embodiment, the bio-control combination further comprises an inert carrier or a nutritional support.

In an embodiment, the nutritional support is selected from gluconate or lactate salts.

In an embodiment, the gluconate salt is selected from alkali salts of gluconate comprising sodium, potassium, zinc, calcium and the like.

In an embodiment, the lactate salt is selected from alkali salts of lactate comprising sodium, potassium, zinc, calcium and the like.

The combinations of the present invention further comprise calcium gluconate as the nutritional support for Candida oleophila.

The combinations of the present invention further comprise calcium lactate as the nutritional support for Candida oleophila.

In an embodiment, the bio-control combination further comprises a fungicide, insecticide, herbicide parasiticide or an acaricide.

In a preferred embodiment, the bio-control combination further comprises a fungicide.

In an embodiment, the fungicide is a systemic or contact fungicide.

In an embodiment, the systemic fungicide is a single fungicide or a combination of one or more systemic fungicides.

In an embodiment, the systemic fungicide is a combination of at least two fungicides.

In an embodiment, the systemic fungicides in the combinations may be selected from nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inductors, fungicides with unknown modes of action, fungicide with no classification, or biologicals with multiple mode of action.

The present invention provides a bio-control composition comprising an antagonistic yeast, a bicarbonate or carbonate salt of a metal and an agriculturally acceptable excipient, for controlling and preventing post-harvest diseases in agricultural produce including cultivated plants, foliage, fruits, root/tuber crops and vegetables.

In an embodiment, the present invention provides a bio-control composition comprising;
(a) a biologically effective amount of an antagonistic yeast;
(b) a stabilizing amount of a bicarbonate or carbonate salt of an alkali or alkaline earth metal, and
(c) an agriculturally acceptable excipient.

In an embodiment, the biological component comprises an antagonistic yeast species selected from Candida sp. Saccharomyces sp. Candida oleophila, Saccharomyces cerevisiae, Saccharomyces pombe and the like.

In a preferred embodiment, the present invention provides a bio-control composition comprising;
(a) a biologically effective amount of Candida oleophila;
(b) a stabilizing amount of a bicarbonate or carbonate salt of an alkali or alkaline earth metal, and
(c) an agriculturally acceptable excipient.

In one preferred embodiment, the present invention provides a bio-control composition comprising;
(a) a biologically effective amount of Candida oleophila;
(b) a stabilizing amount of a bicarbonate salt, and
(c) an agriculturally acceptable excipient.

In an embodiment, the present invention provides a bio-control composition comprising;
(a) a biologically effective amount of Candida oleophila Montrocher strain O, MUCL-40564;
(b) a stabilizing amount of a bicarbonate or carbonate salt of an alkali or alkaline earth metal, and
(c) an agriculturally acceptable excipient.

In an embodiment, the stabilizing amount of bicarbonate or carbonate salt of an alkali or alkaline earth metal is ranging from 0.1% to 10% w/v of the composition.

In a preferred embodiment, the stabilizing amount of a bicarbonate or carbonate salt of an alkali or alkasline earth metal is ranging from 1% to 5% w/v by weight of the composition.

In an embodiment, the stabilizing amount of sodium bicarbonate is ranging from 0.1% to 10% w/v of the composition.

In a preferred embodiment, the stabilizing amount of sodium bicarbonate is ranging from 1% to 5% w/v by weight of the composition.

In an embodiment, the pH of the composition is ranging from 6 to 8.

In an embodiment, the present invention provides a bio-control composition comprising Candida oleophila and a bicarbonate or carbonate salt of a metal.

In an embodiment, Candida oleophila is in a concentration from 0.1 to 5% w/v of the combination.

In a preferred embodiment, Candida oleophila is in a concentration from 0.1 to 3% w/v of the combination.

In an embodiment, Candida oleophila strain O is in a concentration from 0.1 to 5% w/v of the combination.

In a preferred embodiment, Candida oleophila strain O is in a concentration from 0.1 to 3% w/v of the combination.

Accordingly, the biologically effective amount of Candida oleophila is from 0.1×10¹ cfu/g to 5×10¹⁵ cfu/g of the combination.

In an embodiment, the biologically effective amount of Candida oleophila is from 0.5×10¹⁰ cfu/g to 5×10¹⁰ cfu/g of the combination.

In a preferred embodiment, the biologically effective amount of Candida oleophila is from 1×10¹⁰ cfu/g to 4×10¹⁰ cfu/g of the combination.

In a preferred embodiment, the biologically effective amount of Candida oleophila is 3×10¹⁰ cfu/g of the combination.

The composition further comprises a nutritional support or a carrier for the growth and maintenance of the activity of Candida oleophila, such a support is selected from gluconate or lactate salts.

In an embodiment, the gluconate salt is selected from alkali salts of gluconate comprising sodium, potassium, zinc, calcium and the like.

In an embodiment, the lactate salt is selected from alkali salts of lactate comprising sodium, potassium, zinc, calcium and the like.

The compositions of the present invention further comprise calcium gluconate as the nutritional support for Candida oleophila.

The compositions of the present invention further comprise calcium lactate as the nutritional support for Candida oleophila.

In an embodiment, the present invention provides a biocontrol composition comprising a bicarbonate or carbonate salt of an alkali or alkali earth metal selected from sodium, calcium or potassium.

In an embodiment, the bicarbonate salt of sodium is selected from the group comprising sodium bicarbonate or sodium carbonate.

In a preferred embodiment, the stabilizing amount of bicarbonate salt is sodium bicarbonate.

In an embodiment, the stabilizing amount of sodium bicarbonate is in a concentration ranging from 0.01% to 5% w/v.

In a preferred embodiment, the stabilizing amount of sodium bicarbonate is in a concentration ranging from 1% to 2% w/v.

In an embodiment, the present invention provides a bio-control composition comprising Candida oleophila and/or one or more of its growth by-products and a bicarbonate or carbonate salt of a metal.

The term growth by-products include biosurfactants, killer toxins, enzymes and/or other metabolites produced by Candida oleophila.

In an embodiment, Candida oleophila and a bicarbonate or carbonate salt of a metal is in a weight ratio of 0.01:1 to 1:5.

In a preferred embodiment, Candida oleophila and a bicarbonate or carbonate salt of a metal is in a weight ratio of 0.1:1.

In an embodiment, the fruits are selected from the species of Musa spp, Malus spp., Pyrus spp., Citrus fruits, Fragaria ananassa.

In an embodiment, the cultivated plants, in particular the kind of tomato, grapevine and strawberry, as well as flowers and other ornamental plants.

The fungal pathogens can be but are not limited to the species of Botrytis cinerea, Penicillium expansum, P. digitatum, P. italicum, and/or Rhizopus spp.

In an embodiment, the composition optionally comprises an essential oil selected from cinnamon zeylanicum, bergamot, chamomile german, chamomile maroc, chamomile roman, clove buds, citrus essential oils, eucalyptus globulus, frankincense, fennel, hyssop, juniper, lemon grass, mountain savoury, niaouli, red thyme, rosemary, rose geranium, tagestes and ylang ylang.

In one embodiment, the essential oil is preferably cinnamon aldehyde.

In one more embodiment, the present invention provides a bio-control combination or composition comprising;
(a) a biologically effective amount of an antagonistic yeast;
(b) a stabilizing amount of a bicarbonate or carbonate salt of an alkali or alkaline earth metal, and
(c) an essential oil.

In one more preferred embodiment, the present invention provides a bio-control combination or composition comprising;
(a) a biologically effective amount of Candida oleophila,
(b) a stabilizing amount of a bicarbonate or carbonate salt of an alkali or alkaline earth metal, and
(c) an effective amount of cinnamon aldehyde as the essential oil.

In an embodiment, the effective amount of cinnamon aldehyde is ranging from 2% to 40% w/v.

In an embodiment, the effective amount of cinnamon aldehyde is ranging from 5% to 30% w/v.

The biocontrol composition further comprises a buffering agent selected from sodium hypochlorite, calcium hypochlorite, and sodium carbonate.

In a further embodiment, the present invention provides a bio-control combination or composition comprising;
(a) a biologically effective amount of an antagonistic yeast;
(b) a stabilizing amount of a bicarbonate or carbonate salt of an alkali or alkaline earth metal, and
(c) a buffering agent.

In an embodiment, the present invention provides a bio-control combination or composition comprising;
(a) a biologically effective amount of Candida oleophila;
(b) a stabilizing amount of a bicarbonate or carbonate salt of an alkali or alkaline earth metal, and
(c) a buffering agent selected from sodium hypochlorite, calcium hypochlorite, and sodium carbonate.

In an embodiment, the composition is formulated for application to surface of agricultural produce, soil, seeds, plant propagation material, whole plants or plant parts including, but not limited to, roots, tubers, stems, flowers, leaves and the vascular system.

In an embodiment, the composition is formulated for application to the surface of agricultural produce including fruits, vegetables and root or tuber crops.

In certain embodiments, the composition is formulated as, for example, concentrated liquid, dust, granules, microgranules, pellets, wettable powder, flowable powder, emulsions, microcapsules, oils or aerosols.

In a preferred embodiment, the composition is formulated to be suitable for surface treatment of post-harvest produce.

In an embodiment, the composition is formulated to be suitable as a soil treatment.

In one embodiment, the composition can be mixed and/or applied with a fertilizer or another source of plant nutrients such as nitrogen-phosphorous-potassium (NPK) and micronutrients. The materials and the quantities thereof can be determined by an agricultural and/or microbiological scientist having the benefit of the subject disclosure.

In one more embodiment, the composition comprises plant metabolites including flavonoids, terpenoids, phenols, aldehydes, alkaloids, lipids, terpenes, saponins and other carbohydrates.

In an embodiment, the compositions can be formulated into either solid or liquid formulations that are suitable for application to plant propagation material. The formulation may be made as known formulation types such as wettable powders (WP), solutions (LS), emulsions(ES), suspension concentrates (FS), water dispersible granules (WG), and aqueous suspension concentrates (CS).

The formulation may be applied by various methods such methods using conventional treating techniques and machines, such as fluidized bed techniques, the roller mill method, drones, rotostatic seed treaters, and drum coaters, spouted beds, etc. Pre-and post-coating procedures such as sizing etc., may also be carried out. Such procedures are known in the art.

In an embodiment, the present invention provides a method of controlling and/or preventing post-harvest pathogenic infections in agricultural produce, the method comprising applying the surface of such agricultural produce with a biocontrol combination or a composition comprising an antagonistic yeast and a stabilizing amount of a bicarbonate or carbonate salt of an alkali or alkaline earth metal.

In an embodiment, the present invention provides a method of controlling and/or preventing post-harvest fungal infections in agricultural produce, the method comprising: applying agricultural produce with a biocontrol combination or a composition comprising Candida oleophila and a stabilizing amount of a bicarbonate or carbonate salt of an alkali or alkaline earth metal.

In an embodiment, the present invention provides a method of controlling and/or preventing post-harvest fungal infections in agricultural produce, the method comprising, applying agricultural produce with a biocontrol combination comprising Candida oleophila and a stabilizing amount of a bicarbonate or carbonate salt of an alkali or alkaline earth metal, wherein the weight ratio of Candida oleophila and the bicarbonate or carbonate salt is from 0.01:1 to 1:5.

In an embodiment, the present invention provides a method of controlling and/or preventing post-harvest fungal infections in agricultural produce, the method comprising, applying agricultural produce with a biocontrol composition comprising Candida oleophila and a stabilizing amount of a bicarbonate or carbonate salt of an alkali or alkaline earth metal, wherein the weight ratio of Candida oleophila and the bicarbonate or carbonate salt is from 0.01:1 to 1:5.

In an embodiment, the present invention provides a method of controlling and/or preventing post-harvest fungal infections in agricultural produce, the method comprising, applying agricultural produce with a biocontrol combination comprising Candida oleophila strain O and sodium bicarbonate, wherein the weight ratio of Candida oleophila and sodium bicarbonate is from 0.01:1 to 1:5.

In an embodiment, the step of applying the bio-control composition comprises spraying the biocontrol combination or composition on fruits in storage containers or during post-harvest handling procedures, treating or contacting or applying the surface of fruits with the biocontrol composition, immersing the agricultural produce in a dip tank comprising the biocontrol composition, and such other procedures for a specific interval of time.

In a preferred embodiment, the present invention provides a method of controlling and/or preventing post-harvest fungal infections in agricultural produce, the method comprising: applying agricultural produce with a bio-control combination comprising Candida oleophila and sodium bicarbonate, wherein the weight ratio of Candida oleophila and the sodium bicarbonate, is from 0.01:1 to 1:5.

In a most preferred embodiment, the present invention provides a method of controlling and/or preventing post-harvest fungal infections in fruits, the method comprising: applying agricultural produce with a bio-control combination comprising Candida oleophila and sodium bicarbonate, wherein the weight ratio of Candida oleophila and sodium bicarbonate is 0.1:1.

In a preferred embodiment, the present invention provides a method of controlling and/or preventing post-harvest fungal infections in agricultural produce, the method comprising: applying agricultural produce with a biocontrol composition comprising Candida oleophila and sodium bicarbonate, wherein the weight ratio of Candida oleophila and the sodium bicarbonate, is from 0.01:1 to 1:5.

In a most preferred embodiment, the present invention provides a method of controlling and/or preventing post-harvest fungal infections in fruits, the method comprising: applying agricultural produce with a biocontrol composition comprising Candida oleophila and sodium bicarbonate, wherein the weight ratio of Candida oleophila and sodium bicarbonate is 0.1:1.

In an embodiment, the present invention provides a method of controlling and/or preventing post-harvest fungal infections in citrus fruits, the method comprising: applying agricultural produce with a biocontrol combination comprising Candida oleophila and sodium bicarbonate, wherein the weight ratio of Candida oleophila and sodium bicarbonate is from 0.01:1 to 1:5.

In a preferred embodiment, the present invention provides a method of controlling and/or preventing post-harvest fungal infections in citrus fruits, the method comprising: applying citrus fruits with a biocontrol combination comprising Candida oleophila and sodium bicarbonate, wherein the weight ratio of Candida oleophila and sodium bicarbonate is 0.1:1.

In an embodiment, the present invention provides a method of controlling and/or preventing post-harvest fungal infections in citrus fruits, the method comprising: applying agricultural produce with a biocontrol composition comprising Candida oleophila and sodium bicarbonate, wherein the weight ratio of Candida oleophila and the sodium bicarbonate is from 0.01:1 to 1:5.

In a preferred embodiment, the present invention provides a method of controlling and/or preventing post-harvest fungal infections in citrus fruits, the method comprising: applying citrus fruits with a biocontrol composition comprising Candida oleophila and sodium bicarbonate, wherein the weight ratio of Candida oleophila and the sodium bicarbonate is 0.1:1.

In an embodiment, the present invention provides a method of controlling and/or preventing post-harvest fungal infections in bananas, the method comprising: applying bananas with a biocontrol combination comprising Candida oleophila and sodium bicarbonate, wherein the weight ratio of Candida oleophila and sodium bicarbonate is from 0.01:1 to 1:5.

In a preferred embodiment, the present invention provides a method of controlling and/or preventing post-harvest fungal infections in bananas the method comprising: applying bananas with a biocontrol combination comprising Candida oleophila and sodium bicarbonate, wherein the weight ratio of Candida oleophila and sodium bicarbonate is 0.1:1.

In an embodiment, the present invention provides a method of controlling and/or preventing post-harvest fungal infections in bananas, the method comprising: applying bananas with a biocontrol composition comprising Candida oleophila and sodium bicarbonate, wherein the weight ratio of Candida oleophila and the sodium bicarbonate is from 0.01:1 to 1:5.

In a preferred embodiment, the present invention provides a method of controlling and/or preventing post-harvest fungal infections in bananas the method comprising: applying bananas with a biocontrol composition comprising Candida oleophila and sodium bicarbonate, wherein the weight ratio of Candida oleophila and the sodium bicarbonate is 0.1:1.

In an embodiment, the present invention provides a method of controlling and/or preventing post-harvest fungal infections in stone fruits, the method comprising: applying stone fruits with a biocontrol combination comprising Candida oleophila and sodium bicarbonate, wherein the weight ratio of Candida oleophila and sodium bicarbonate is from 0.01:1 to 1:5.

In a preferred embodiment, the present invention provides a method of controlling and/or preventing post-harvest fungal infections in stone fruits the method comprising: applying stone fruits with a biocontrol combination comprising Candida oleophila and sodium bicarbonate, wherein the weight ratio of Candida oleophila and sodium bicarbonate is 0.1:1.

In an embodiment, the present invention provides a method of controlling and/or preventing post-harvest fungal infections in stone fruits, the method comprising: applying stone fruits with a biocontrol composition comprising Candida oleophila and sodium bicarbonate, wherein the weight ratio of Candida oleophila and the sodium bicarbonate is from 0.01:1 to 1:5.

In a preferred embodiment, the present invention provides a method of controlling and/or preventing post-harvest fungal infections in stone fruits, the method comprising: applying stone fruits with a biocontrol composition comprising Candida oleophila and sodium bicarbonate, wherein the weight ratio of Candida oleophila and the sodium bicarbonate is 0.1:1.

In an embodiment, the present invention provides a method of controlling and/or preventing post-harvest fungal infections in pome fruits, method comprising: applying pome fruits with a biocontrol combination comprising Candida oleophila and sodium bicarbonate, wherein the weight ratio of Candida oleophila and sodium bicarbonate is from 0.01:1 to 1:5.

In a preferred embodiment, the present invention provides a method of controlling and/or preventing post-harvest fungal infections in pome fruits the method comprising: applying pome fruits with a biocontrol combination comprising Candida oleophila and sodium bicarbonate, wherein the weight ratio of Candida oleophila and sodium bicarbonate is 0.1:1.

In an embodiment, the present invention provides a method of controlling and/or preventing post-harvest fungal infections in pome fruits, the method comprising: applying pome fruits with a biocontrol composition comprising Candida oleophila and sodium bicarbonate, wherein the weight ratio of Candida oleophila and the sodium bicarbonate is from 0.01:1 to 1:5.

In a preferred embodiment, the present invention provides a method of controlling and/or preventing post-harvest fungal infections in pome fruits, the method comprising: applying pome fruits with a biocontrol composition comprising Candida oleophila and sodium bicarbonate, wherein the weight ratio of Candida oleophila and the sodium bicarbonate is 0.1:1.

In an embodiment, the method of controlling and/or preventing post-harvest fungal infections in agricultural produce comprises immersing the agricultural produce in a dip tank comprising a biocontrol combination or composition comprising Candida oleophila and a stabilizing amount of a bicarbonate or carbonate salt of an alkali or alkaline earth metal.

In a preferred embodiment, the method of controlling and/or preventing post-harvest fungal infections in agricultural produce comprises immersing the agricultural produce in a dip tank comprising a biocontrol combination comprising Candida oleophila and a stabilizing amount of a bicarbonate or carbonate salt of an alkali or alkaline earth metal, wherein the weight ratio of Candida oleophila and the bicarbonate or carbonate salt of a metal is from 0.01:1 to 1:5.

In a preferred embodiment, the method of controlling and/or preventing post-harvest fungal infections in bananas comprises immersing harvested bananas in a dip tank comprising a biocontrol combination comprising Candida oleophila and a stabilizing amount of a bicarbonate or carbonate salt of an alkali or alkaline earth metal, wherein the weight ratio of Candida oleophila and the bicarbonate or carbonate salt of a metal is from 0.01:1 to 1:5.

In a preferred embodiment, the method of controlling and/or preventing post-harvest fungal infections in citrus fruits comprises immersing said fruits in a dip tank comprising a biocontrol combination comprising Candida oleophila and a stabilizing amount of a bicarbonate or carbonate salt of an alkali or alkaline earth metal, wherein the weight ratio of Candida oleophila and the bicarbonate or carbonate salt of a metal is from 0.01:1 to 1:5.

In a preferred embodiment, the method of controlling and/or preventing post-harvest fungal infections in agricultural produce comprises immersing the agricultural produce in a dip tank comprising a biocontrol composition including Candida oleophila and a stabilizing amount of a bicarbonate or carbonate salt of an alkali or alkaline earth metal, wherein the weight ratio of Candida oleophila and the bicarbonate or carbonate salt of a metal is from 0.01:1 to 1:5.

In a preferred embodiment, the method of controlling and/or preventing post-harvest fungal infections in bananas comprises immersing harvested bananas in a dip tank comprising a biocontrol composition including Candida oleophila and a stabilizing amount of a bicarbonate or carbonate salt of an alkali or alkaline earth metal, wherein the weight ratio of Candida oleophila and the bicarbonate or carbonate salt of a metal is from 0.01:1 to 1:5.

In a preferred embodiment, the method of controlling and/or preventing post-harvest fungal infections in citrus fruits comprises immersing said fruits in a dip tank comprising a biocontrol composition including Candida oleophila and a stabilizing amount of a bicarbonate or carbonate salt of an alkali or alkaline earth metal, wherein the weight ratio of Candida oleophila and the bicarbonate or carbonate salt of a metal is from 0.01:1 to 1:5.

Accordingly, the dip tanks have a capacity of holding 5 L to 20 L of the biocontrol composition.

In an embodiment, Candida oleophila is in a biologically effective amount ranging from 0.5 g/L to 3 g/L and the metal salt is in an amount ranging from 10 to 50 g/L.

In an embodiment, Candida oleophila is 2 g/L and the metal salt is 20 g/L.

In an embodiment, Candida oleophila is 2 g/L and sodium bicarbonate is 20 g/L.

In an embodiment, the step of immersing the agricultural produce in a dip tank comprising a biocontrol composition is carried out for a period of 5 seconds to 20 minutes.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 20 L per metric ton of agricultural produce, wherein the weight ratio of Candida oleophila and the bicarbonate or carbonate salt of a metal is from 0.01:1 to 1:5.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 15 L per metric ton of agricultural produce, wherein the weight ratio of Candida oleophila and the bicarbonate or carbonate salt of a metal is from 0.01:1 to 1:5.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 5 L per metric ton of agricultural produce, wherein the weight ratio of Candida oleophila and the bicarbonate or carbonate salt of a metal is from 0.01:1 to 1:5.

In a preferred embodiment, the method of controlling and/or preventing post-harvest fungal infections in bananas comprises spraying bananas with a biocontrol combination including Candida oleophila and a stabilizing amount of a bicarbonate or carbonate salt of an alkali or alkaline earth metal in an amount of 1 L to 20 L per metric ton of bananas, wherein the weight ratio of Candida oleophila and the bicarbonate or carbonate salt of a metal is from 0.01:1 to 1:5

In a preferred embodiment, the method of controlling and/or preventing post-harvest fungal infections in bananas comprises spraying bananas with a biocontrol combination including Candida oleophila and a stabilizing amount of a bicarbonate or carbonate salt of an alkali or alkaline earth metal in an amount of 1 L to 15 L per metric ton of bananas, wherein the weight ratio of Candida oleophila and the bicarbonate or carbonate salt of a metal is from 0.01:1 to 1:5.

In a preferred embodiment, the method of controlling and/or preventing post-harvest fungal infections in bananas comprises spraying bananas with a biocontrol combination including Candida oleophila and a stabilizing amount of a bicarbonate or carbonate salt of an alkali or alkaline earth metal in an amount of 1 L to 5 L per metric ton of bananas, wherein the weight ratio of Candida oleophila and the bicarbonate or carbonate salt of a metal is from 0.01:1 to 1:5.

In a preferred embodiment, the method of controlling and/or preventing post-harvest fungal infections in citrus fruits comprises spraying citrus fruits with a biocontrol combination including Candida oleophila and a stabilizing amount of a bicarbonate or carbonate salt of an alkali or alkaline earth metal in an amount of 1 L to 20 L per metric ton of citrus fruits, wherein the weight ratio of Candida oleophila and the bicarbonate or carbonate salt of a metal is from 0.01:1 to 1:5

In a preferred embodiment, the method of controlling and/or preventing post-harvest fungal infections in citrus fruits comprises spraying citrus fruits with a biocontrol combination including Candida oleophila and a stabilizing amount of a bicarbonate or carbonate salt of an alkali or alkaline earth metal in an amount of 1 L to 10 L per metric ton of citrus fruits, wherein the weight ratio of Candida oleophila and the bicarbonate or carbonate salt of a metal is from 0.01:1 to 1:5.

In a preferred embodiment, the method of controlling and/or preventing post-harvest fungal infections in citrus fruits comprises spraying citrus fruits with a biocontrol combination including Candida oleophila and a stabilizing amount of a bicarbonate or carbonate salt of an alkali or alkaline earth metal in an amount of 1 L to 5 L per metric ton of citrus fruits, wherein the weight ratio of Candida oleophila and the bicarbonate or carbonate salt of a metal is from 0.01:1 to 1:5.

In a preferred embodiment, the method of controlling and/or preventing post-harvest fungal infections in agricultural produce comprises spraying the agricultural produce with a biocontrol composition including Candida oleophila and a stabilizing amount of a bicarbonate or carbonate salt of an alkali or alkaline earth metal in an amount of 1 L to 5 L per metric ton of agricultural produce, wherein the weight ratio of Candida oleophila and the bicarbonate or carbonate salt of a metal is from 0.01:1 to 1:5.

In a preferred embodiment, the method of controlling and/or preventing post-harvest fungal infections in bananas comprises spraying bananas with a biocontrol composition including Candida oleophila and a stabilizing amount of a bicarbonate or carbonate salt of an alkali or alkaline earth metal in an amount of 1 L to 5 L per metric ton of bananas, wherein the weight ratio of Candida oleophila and the bicarbonate or carbonate salt of a metal is from 0.01:1 to 1:5.

In a preferred embodiment, the method of controlling and/or preventing post-harvest fungal infections in citrus fruits comprises spraying citrus fruits with a biocontrol composition including Candida oleophila and a stabilizing amount of a bicarbonate or carbonate salt of an alkali or alkaline earth metal in an amount of 1 L to 5 L per metric ton of citrus fruits, wherein the weight ratio of Candida oleophila and the bicarbonate or carbonate salt of a metal is from 0.01:1 to 1:5.

In an embodiment, the agricultural produce is treated with the bio-control combination of the present invention and subjected to dying by air drying, solar-drying, vacuum drying, freeze drying.

The air-drying process can take place by passing fruits on a conveyor belt or on transferrable trays in a drying tunnel. The drying duration can vary from 1 second to 20 minutes.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 20 L per metric ton of agricultural produce and subjecting the produce to drying through a drying tunnel.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 15 L per metric ton of agricultural produce and subjecting the produce to drying through a drying tunnel.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 10 L per metric ton of agricultural produce and subjecting the produce to drying through a drying tunnel.

In a preferred embodiment, the method of controlling and/or preventing post-harvest fungal infections in agricultural produce comprises spraying the agricultural produce with a biocontrol combination including Candida oleophila and a stabilizing amount of a bicarbonate or carbonate salt of an alkali or alkaline earth metal in an amount of 1 L to 5 L per metric ton of agricultural produce and subjecting the produce to drying through a drying tunnel.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal,
   wherein the application is made in an amount of 1 L to 20 L per metric ton of agricultural produce.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal,
   wherein the application is made in an amount of 1 L to 10 L per metric ton of agricultural produce.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal,
   wherein the application is made in an amount of 1 L to 5 L per metric ton of agricultural produce.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 20 L per metric ton of agricultural produce.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 15 L per metric ton of agricultural produce.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 10 L per metric ton of agricultural produce.

In an embodiment, the method of controlling and/or preventing post-harvest fungal infections in agricultural produce comprises applying the agricultural produce either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 5 L per metric ton of agricultural produce.

In an embodiment, the method of controlling and/or preventing post-harvest fungal infections in bananas comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal, and
   wherein the application is made in an amount of 1 L to 20 L per metric ton of bananas.

In an embodiment, the method of controlling and/or preventing post-harvest fungal infections in bananas comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal, and
   wherein the application is made in an amount of 1 L to 15 L per metric ton of bananas.

In an embodiment, the method of controlling and/or preventing post-harvest fungal infections in bananas comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal, and
   wherein the application is made in an amount of 1 L to 10 L per metric ton of bananas.

In an embodiment, the method of controlling and/or preventing post-harvest fungal infections in bananas comprises applying the agricultural produce either simultaneously or concurrently with a biocontrol combination comprising;
(i) a biologically effective amount of Candida oleophila, and
(ii) a stabilizing amount of a bicarbonate or carbonate salt of an alkali or alkaline earth metal, and
   wherein the application is made in an amount of 1 L to 5 L per metric ton of bananas.

In an embodiment, the method of controlling and/or preventing post-harvest fungal infections in bananas comprises applying bananas either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 20 L per metric ton of bananas.

In an embodiment, the method of controlling and/or preventing post-harvest fungal infections in bananas comprises applying bananas either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 15 L per metric ton of bananas.

In an embodiment, the method of controlling and/or preventing post-harvest fungal infections in bananas comprises applying bananas either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 10 L per metric ton of bananas.

In an embodiment, the method of controlling and/or preventing post-harvest fungal infections in bananas comprises applying bananas either simultaneously or concurrently with a biocontrol combination comprising;
(i) a biologically effective amount of Candida oleophila, and
(ii) a stabilizing amount of sodium bicarbonate,
   wherein the application is made in an amount of 1 L to 5 L per metric ton of bananas.

In an embodiment, the method of controlling and/or preventing post-harvest fungal infections in citrus fruits comprises applying citrus fruits either simultaneously or concurrently with the following components;
(i) a biologically effective amount of Candida oleophila, and
(ii) a stabilizing amount of a bicarbonate or carbonate salt of an alkali or alkaline earth metal,
   wherein the application is made in an amount of 1 L to 20 L per metric ton of citrus fruits.

In an embodiment, the method of controlling and/or preventing post-harvest fungal infections in citrus fruits comprises applying citrus fruits either simultaneously or concurrently with the following components;
(i) a biologically effective amount of Candida oleophila, and
(ii) a stabilizing amount of a bicarbonate or carbonate salt of an alkali or alkaline earth metal,
   wherein the application is made in an amount of 1 L to 15 L per metric ton of citrus fruits.

In an embodiment, the method of controlling and/or preventing post-harvest fungal infections in citrus fruits comprises applying citrus fruits either simultaneously or concurrently with the following components;
(i) a biologically effective amount of Candida oleophila, and
(ii) a stabilizing amount of a bicarbonate or carbonate salt of an alkali or alkaline earth metal,
   wherein the application is made in an amount of 1 L to 10 L per metric ton of citrus fruits.

In an embodiment, the method of controlling and/or preventing post-harvest fungal infections in citrus fruits comprises applying citrus fruits either simultaneously or concurrently with the following components;
(i) a biologically effective amount of Candida oleophila, and
(ii) a stabilizing amount of a bicarbonate or carbonate salt of an alkali or alkaline earth metal,
   wherein the application is made in an amount of 1 L to 5 L per metric ton of citrus fruits.

In an embodiment, the method of controlling and/or preventing post-harvest fungal infections in pome fruits comprises applying pome fruits either simultaneously or concurrently with the following components;
(i) a biologically effective amount of Candida oleophila, and
(ii) a stabilizing amount of sodium bicarbonate,
   wherein the application is made in an amount of 1 L to 20 L per metric ton of pome fruits.

In an embodiment, the method of controlling and/or preventing post-harvest fungal infections in pome fruits comprises applying pome fruits either simultaneously or concurrently with the following components;
(i) a biologically effective amount of Candida oleophila, and
(ii) a stabilizing amount of sodium bicarbonate,
   wherein the application is made in an amount of 1 L to 15 L per metric ton of pome fruits.

In an embodiment, the method of controlling and/or preventing post-harvest fungal infections in pome fruits comprises applying pome fruits either simultaneously or concurrently with the following components;
(i) a biologically effective amount of Candida oleophila, and
(ii) a stabilizing amount of sodium bicarbonate,
   wherein the application is made in an amount of 1 L to 10 L per metric ton of pome fruits.

In an embodiment, the method of controlling and/or preventing post-harvest fungal infections in pome fruits comprises applying pome fruits either simultaneously or concurrently with the following components;
(i) a biologically effective amount of Candida oleophila, and
(ii) a stabilizing amount of sodium bicarbonate,
   wherein the application is made in an amount of 1 L to 5 L per metric ton of pome fruits.

In an embodiment, the method of controlling and/or preventing post-harvest fungal infections in stone fruits comprises applying stone fruits either simultaneously or concurrently with the following components;
(i) a biologically effective amount of Candida oleophila, and
(ii) a stabilizing amount of sodium bicarbonate,
   wherein the application is made in an amount of 1 L to 20 L per metric ton of stone fruits.

In an embodiment, the method of controlling and/or preventing post-harvest fungal infections in stone fruits comprises applying stone fruits either simultaneously or concurrently with the following components;
i) a biologically effective amount of Candida oleophila, and
(ii) a stabilizing amount of sodium bicarbonate,
   wherein the application is made in an amount of 1 L to 15 L per metric ton of stone fruits.

In an embodiment, the method of controlling and/or preventing post-harvest fungal infections in stone fruits comprises applying stone fruits either simultaneously or concurrently with the following components;
(i) a biologically effective amount of Candida oleophila, and
(ii) a stabilizing amount of sodium bicarbonate,
   wherein the application is made in an amount of 1 L to 10 L per metric ton of stone fruits.

In an embodiment, the method of controlling and/or preventing post-harvest fungal infections in stone fruits comprises applying stone fruits either simultaneously or concurrently with the following components;
(i) a biologically effective amount of Candida oleophila, and
(ii) a stabilizing amount of sodium bicarbonate,
   wherein the application is made in an amount of 1 L to 5 L per metric ton of stone fruits.

In an embodiment, the method of controlling and/or preventing post-harvest fungal infections in agricultural produce comprises applying the agricultural produce either simultaneously or concurrently with the following components;
(i) a biologically effective amount of Candida oleophila,
(ii) a stabilizing amount of dissolved inorganic carbon added in the form of a bicarbonate or carbonate salt of an alkali or alkaline earth metal, and
(iii) an essential oil,
   wherein each application is made in an amount of 1 L to 5 L per metric ton of agricultural produce.

In a preferred embodiment, the method of controlling and/or preventing post-harvest fungal infections in bananas comprises applying the agricultural produce either simultaneously or concurrently with the following components;
(i) a biologically effective amount of Candida oleophila,
(ii) a stabilizing amount of dissolved inorganic carbon added in the form of a bicarbonate or carbonate salt of an alkali or alkaline earth metal, and
(iii) an effective amount of cinnamon aldehyde as the essential oil,
   wherein each application is made in an amount of 1 L to 5 L per metric ton of agricultural produce.

In a preferred embodiment, the method of controlling and/or preventing post-harvest fungal infections in bananas comprises applying bananas either simultaneously or concurrently with the following components;
(i) a biologically effective amount of Candida oleophila,
(ii) a stabilizing amount of dissolved inorganic carbon added in the form of a bicarbonate or carbonate salt of an alkali or alkaline earth metal, and
(iii) an effective amount of cinnamon aldehyde as the essential oil,
   wherein each application is made in an amount of 1 L to 5 L per metric ton of bananas.

In a preferred embodiment, the method of controlling and/or preventing post-harvest fungal infections in citrus fruits comprises applying citrus fruits either simultaneously or concurrently with the following components;
(i) a biologically effective amount of Candida oleophila,
(ii) a stabilizing amount of a bicarbonate or carbonate salt of an alkali or alkaline earth metal, and
(iii) an effective amount of cinnamon aldehyde as the essential oil,
   wherein each application is made in an amount of 1 L to 5 L per metric ton of citrus fruits.

The composition of the invention is useful for the controlling and preventing post-harvest diseases in a variety of fruits including, but not limited to, all cultivars of-citrus fruits, grapes, apples, pears, tomatoes, persimmons and the like. Suitable citrus fruits include, but are not limited to, grapefruits, oranges, lemons and the like.

In an embodiment, the present invention provides a method of controlling and/or preventing post-harvest fungal infections in banana, the method comprising: applying the surface of such agricultural produce with a biocontrol composition comprising Candida oleophila strain and sodium bicarbonate, wherein the weight ratio of Candida oleophila and the sodium bicarbonate is from 0.01:1 to 1:5.

In an embodiment, the present invention provides a method of controlling and/or preventing post-harvest fungal infections in banana, the method comprising: applying the surface of such agricultural produce with a biocontrol composition comprising Candida oleophila strain and sodium bicarbonate, wherein the weight ratio of Candida oleophila and the sodium bicarbonate is from 0.01:1 to 1:5.

In a preferred embodiment, the present invention provides a method of controlling and/or preventing post-harvest crown rot infection in banana, the method comprising: applying the surface of bananas with a biocontrol composition comprising Candida oleophila strain and sodium bicarbonate, wherein the weight ratio of Candida oleophila and the sodium bicarbonate, is from 0.01:1 to 1:5.

In a preferred embodiment, the present invention provides a method of controlling and/or preventing post-harvest crown rot infection in banana, the method comprising: applying the surface of bananas with a biocontrol composition comprising Candida oleophila strain and sodium bicarbonate, wherein the weight ratio of Candida oleophila and the sodium bicarbonate, is 0.1:1.

Accordingly, the fungal pathogens associated with crown rot, a disease complex caused by several fungi, an economically significant postharvest disease of banana plants, include Lasiodiplodia theobromae, Thielaviopsis paradoxa, Colletotrichum musae, and Fusarium verticillioides.

In one embodiment, methods are provided for controlling and preventing Fusarium spp. causing Fusarium wilt in banana.

In one embodiment, the subject method can be used to control Fusarium oxysporum, and/or Fusarium oxysporum spp. cubense. Thus, the method can be used for treating and/or preventing, for example, Panama Disease and/or Fusarium wilt in banana plants.

In additional embodiments, the method can be used for controlling Fusarium fungi, such as, for example, F. avenaceurn, F. bubigeurn, F. culmorum, F. graminearum, F. langsethiae, F. oxysporum, F. proliferaturn, F. sporotrichioides, F. poae, F. reseum, F. solani, F. tricinctum, F. verticillioides, F. virguliforme, F. xylariodides and any other Fusarium fungi that can infect plants.

In an embodiment, the present invention provides a method of controlling and/or preventing a pathogenic infection in plants, the method comprising: applying the plant or a plant part or a locus thereof with a biocontrol composition, wherein the bio-control composition comprises an antagonistic yeast and/or one or more metal salts.

The diseases treated by the combinations and compositions of the present invention are as follows:

Diseases of citrus: melanose (Diaporthe citri), scab (Elsinoe fawcetti), Penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of persimmon: anthracnose (Gloeosporium kaki), and leaf spot (Cercospora kaki, Mycosphaerella nawae).

Diseases of strawberry: powdery mildew (Sphaerotheca humuli), and anthracnose (Glomerella cingulata).

Disease of banana: Black sigatoka (Mycosphaerella fijiensis), Yellow sigatoka (Mycosphaerella musicola), Fusarium wilt or Panama disease (Fusarium oxysporum, and/or Fusarium oxysporum spp. cubense.).

Viral diseases of various plants mediated by Polymxa spp. or Olpidium spp. and so on.

It is to be noted herein that the combinations and composition of the present invention are not applied to papaya.

In an embodiment, the method of controlling and/or preventing post-harvest fungal infection caused by green mold in oranges comprises applying oranges with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 20 L per metric ton of agricultural produce.

In an embodiment, the method of controlling and/or preventing post-harvest fungal infection caused by green mold in oranges comprises applying oranges with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 15 L per metric ton of agricultural produce.

In an embodiment, the method of controlling and/or preventing post-harvest fungal infection caused by green mold in oranges comprises applying oranges with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 10 L per metric ton of agricultural produce.

In an embodiment, the method of controlling and/or preventing post-harvest fungal infection caused by green mold in oranges comprises applying oranges with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 5 L per metric ton of agricultural produce.

In an embodiment, the method of controlling and/or preventing post-harvest crown rot infection in bananas comprises applying bananas with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 20 L per metric ton of agricultural produce.

In an embodiment, the method of controlling and/or preventing post-harvest crown rot infection in bananas comprises applying bananas with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 15 L per metric ton of agricultural produce.

In an embodiment, the method of controlling and/or preventing post-harvest crown rot infection in bananas comprises applying bananas with a biocontrol combination comprising;
(i) a biologically effective amount of Candida oleophila, and
(ii) a stabilizing amount of sodium bicarbonate,
   either simultaneously or concurrently, wherein the application is made in an amount of 1 L to 10 L per metric ton of agricultural produce.

In an embodiment, the method of controlling and/or preventing post-harvest crown rot infection in bananas comprises applying bananas with a biocontrol combination comprising
(i) a biologically effective amount of Candida oleophila, and
(ii) a stabilizing amount of sodium bicarbonate,
   either simultaneously or concurrently, wherein the application is made in an amount of 1 L to 5 L per metric ton of agricultural produce.

In an embodiment, the present invention provides use of a bio-control combination or composition comprising Candida oleophila and a bicarbonate or carbonate salt of a metal for controlling post-harvest diseases in agricultural produce.

In an embodiment, the present invention provides use of a bio-control combination or composition comprising Candida oleophila and sodium bicarbonate for controlling post-harvest diseases in oranges.

In an embodiment, the present invention provides use of a bio-control combination or composition comprising Candida oleophila and a bicarbonate or carbonate salt of a metal for controlling Penicillium digitatum in oranges

In an embodiment, the present invention provides use of a bio-control combination or composition comprising Candida oleophila and sodium bicarbonate for controlling post-harvest diseases in bananas.

In an embodiment, the present invention provides use of a bio-control combination or composition comprising Candida oleophila and sodium bicarbonate for controlling crown rot infection in bananas.

In an embodiment, the present invention provides use of a bio-control combination or composition comprising Candida oleophila and sodium bicarbonate for controlling post-harvest diseases in pome fruits.

In an embodiment, the present invention provides use of a bio-control combination or composition comprising Candida oleophila and sodium bicarbonate for controlling post-harvest diseases in stone fruits.

According to an embodiment of the present disclosure, the various components of the bio-control composition can be used individually or already partially or completely mixed with one another to prepare the composition according to the invention. It is also possible for them to be packaged and used further as combination composition such as a kit of parts.

In another aspect, the compositions may be presented in the form of a multi-pack fungicidal product or as a kit-of-parts for controlling target fungi.

It will be understood that the specification and examples are illustrative but not limitative of the present disclosure and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### EXAMPLES

The disclosure will be illustrated with reference to the following examples:

### Example 1

A tank mix bio-control combination was prepared consisting of Candida oleophila strain O and sodium bicarbonate. C. oleophila was supplemented with calcium gluconate as a nutritional support to maintain and enhance the biological properties of the microbe. The microbial component was applied as water dispersible granules. The concentration of C. oleophila strain O was 2.33 g/L (0.23% w/v) and the biologically effective amount of the strain was 3×10¹⁰ cfu/gm. The concentration of the C. oleophila strain O used was varying between 0.1 to 5% w/v of the combination. The sodium bicarbonate content as the stabilizing amount in the tank mix combination was 2% w/v. Alternatively, the sodium bicarbonate content which was used in the bio control combination was ranging from 0.1% to 10% w/v. The bio-control combination as described herein was used for treatment trials in the Example below.

### Example 2

The biocontrol efficacy of the combination of the present invention on post-harvest fungal disease caused by green mold was evaluated. Postharvest green mold is a major postharvest disease of citrus fruit, caused by the necrotrophic fungus Penicillium digitatum (Pd), which leads to huge economic losses. The harvested oranges were treated with the biocontrol combination and then subjected to drying in a drying tunnel. The treatment and the observations are elaborated in table 1 below. The oranges were treated by online spraying of each treatment. The biologically effective amount of Candida oleophila is 3×10¹⁰ cfu/g of the combination. Each application is made at a rate 2 L/tonne of citrus fruits. The observations were made on the treated oranges and the untreated control at 36 days after storage.

TABLE 1
Treatment and observations on % decay
on oranges subjected to drying

| | | | | Application | |
|---|---|---|---|---|---|
| Treat- | | | | rate | % decay |
| ment | | | | (L/tonne of | on |
| No. | Ingredients | Amount | | fruits) | fruits |
| 1. | Untreated control | — | | — | 21 |
| 2. | C. oleophila strain O* | 0.33 | g/L | 2 | 18 |
| 3. | Sodium | 0.9% | w/v | 2 | 15 |
| | bicarbonate | | | | |

| | | | | |
|---|---|---|---|---|
| 4. | C. oleophila strain O* | 0.33 g/L + | 2 | 6 |
| | and Sodium | 0.9% w/v | | |
| | bicarbonate | | | |

*C. oleophila strain O has 2 g/L of calcium gluconate as a nutrition source

The biocontrol combination (treatment 4) as demonstrated in the table above was found to be significantly efficacious in controlling the decay caused by green mold on oranges compared to treatments 1 to 3. The reduction in % decay on citrus fruits caused by green mould was compared vis-à-vis the untreated control, the C. oleophila strain O and sodium bicarbonate individually. The significant efficacy of the present bio-control combination compared to the untreated control is reflected in the difference between the % decays in fruits, i.e. 15%. Further, difference between the % decays in fruits treated with the present bio-control combination compared to C. oleophila strain O is 12%. The difference between the % decays in fruits treated with the present bio-control combination compared to sodium bicarbonate is 9%.

Therefore, it is evident from the considerable difference in % decay in fruits, that the present combination is effective for treating post-harvest fungal infections in agricultural produce.

What is claimed is:

1. A bio-control combination comprising;
(a) a biologically effective amount of Candida oleophila; and
(b) a stabilizing amount of a bicarbonate or carbonate salt of an alkali or alkaline earth metal.

2. The biocontrol combination as claimed in claim 1, wherein the Candida oleophila is Candida oleophila strain O or Candida oleophila-182.

3. The biocontrol combination as claimed in claim 1, the alkali or alkali earth metal is selected from sodium, calcium or potassium.

4. The biocontrol combination as claimed in claims 1 and 3, wherein the bicarbonate or carbonate salt of an alkali or alkaline earth metal is selected from sodium bicarbonate, sodium carbonate, potassium carbonate, potassium bicarbonate, calcium carbonate or calcium bicarbonate.

5. The biocontrol combination as claimed in claim 4, wherein the bicarbonate salt is sodium bicarbonate.

6. The biocontrol combination as claimed in claim 1, wherein the Candida oleophila and bicarbonate or carbonate salt of an alkali or alkaline earth metal are present in a weight ratio of 0.01:1 to 1:5.

7. The biocontrol combination as claimed in claim 1, wherein Candida oleophila is in a concentration ranging from 0.1 to 5% w/v of the combination.

8. The biocontrol combination as claimed in claim 1, wherein the biologically effective amount of Candida oleophila is 1×10¹⁰ cfu/g to 5×10¹⁰ cfu/g of the combination.

9. The biocontrol combination as claimed in claim 1, wherein the stabilizing amount of bicarbonate is 0.1% to 10% w/v of the combination.

10. The biocontrol combination as claimed in claim 1, wherein the stabilizing amount of the bicarbonate salt is 1% to 5% w/v of the combination.

11. The biocontrol combination as claimed in claim 1, wherein the combination further comprises a nutritional support selected from gluconate or lactate salts.

12. The biocontrol combination as claimed in claim 1, wherein the combination further comprises a fungicide, insecticide, herbicide, acaricide or parasiticide.

13. A bio-control combination as claimed in claim 1, the combination comprising;
(a) Candida oleophila strain O in a biologically effective amount ranging from 1×10¹⁰ cfu/g to 5×10¹⁰ cfu/g of; and
(b) sodium bicarbonate in a stabilizing amount ranging from 0.1% to 10% w/v of the combination.

14. A bio-control composition comprising the combination as claimed in claim 1, and an agriculturally acceptable excipient.

15. The biocontrol composition as claimed in claim 14, further comprising an inert carrier or a nutritional support.

16. A method for controlling and/or preventing post-harvest diseases in agricultural produce, said method comprising applying to the agricultural produce the combination as claimed in claim 1; either simultaneously or concurrently, wherein the application is made in an amount of 1 L to 20 L per tonne of agricultural produce.

17. The method as claimed in claim 16, wherein the application is made in an amount of 1 L to 10 L per tonne of agricultural produce.

18. Use of a bio-control combination comprising Candida oleophila and a bicarbonate or carbonate salt of a metal for controlling post-harvest diseases in agricultural produce.
